(19) United States
(12) Patent Application Publication
(10) Pub. No.: US 2018/0341925 A1
(43) Pub. Date: Nov. 29, 2018

(54) SCHEDULING OF MEETINGS

(71) Applicant: Google LLC, Mountain View, CA (US)

(72) Inventors: Matthew John LESKE, Stockholm (SE); Jonas LINDBERG, Stockholm (SE)

(21) Appl. No.: 14/302,763

(22) Filed: Jun. 12, 2014

(51) Int. Cl. G06Q 10/10

(52) U.S. Cl. CPC G06Q 10/1095

(57) ABSTRACT

Implementations generally relate to providing scheduling of meetings. In some implementations, a method includes receiving meeting requests for a plurality of meetings. The method further includes determining efficiency scores for the plurality of meetings. The method further includes scheduling the plurality of meetings based on the efficiency scores.

### BACKGROUND

Video conferencing is often used in business settings, and enables participants to participate in virtual meetings in real-time across geographically dispersed locations. To set up a meeting, a meeting organizer typically determines people to invite to the meeting, determines a time when all invitees are available to the meeting, and then schedules the meeting accordingly.

### SUMMARY

Implementations generally relate to providing scheduling of meetings. In some implementations, a method includes receiving meeting requests for a plurality of meetings. The method further includes determining efficiency scores for the plurality of meetings. The method further includes scheduling the plurality of meetings based on the efficiency scores.

With further regard to the method, in some implementations, each meeting of the plurality of meetings is associated with an efficiency score. In some implementations, each efficiency score is based on interdependencies among meetings. In some implementations, each efficiency score is based on a degree of urgency. In some implementations, each efficiency score is based on temporal proximity to other meetings. In some implementations, the scheduling of the plurality of meetings includes scheduling meetings with higher efficiency scores first. In some implementations, the scheduling of the plurality of meetings includes scheduling meetings for a particular invitee within a predetermined time period. In some implementations, the scheduling of the plurality of meetings includes scheduling meetings for a particular invitee on the same day. In some implementations, the scheduling of the plurality of meetings includes grouping meetings for a particular invitee based on meeting locations. In some implementations, the method further includes determining when there is a change to an ending of a first meeting, and rescheduling at least a second meeting based on the change.

In some implementations, a method includes receiving meeting requests for a plurality of meetings. The method further includes determining efficiency scores for the plurality of meetings, where each meeting of the plurality of meetings is associated with an efficiency score, where each efficiency score is based on interdependencies among meetings, and where each efficiency score is based on a degree of urgency, and where each efficiency score is based on temporal proximity to other meetings. The method further includes scheduling the plurality of meetings based on the efficiency scores, where the scheduling of the plurality of meetings includes scheduling meetings with higher efficiency scores first, where the scheduling of meetings includes scheduling meetings for a particular invitee within a predetermined time period, and where the scheduling of meetings includes grouping meetings for a particular invitee based on meeting locations.

In some implementations, a system includes one or more processors, and logic encoded in one or more tangible media for execution by the one or more processors. When executed, the logic is operable to perform operations including: receiving meeting requests for a plurality of meetings; determining efficiency scores for the plurality of meetings; and scheduling the plurality of meetings based on the efficiency scores.

With further regard to the system, in some implementations, each meeting of the plurality of meetings is associated with an efficiency score. In some implementations, each efficiency score is based on interdependencies among meetings. In some implementations, each efficiency score is based on a degree of urgency. In some implementations, each efficiency score is based on temporal proximity to other meetings. In some implementations, to schedule the plurality of meetings, the logic when executed is further operable to perform operations including scheduling meetings with higher efficiency scores first. In some implementations, to schedule the plurality of meetings, the logic when executed is further operable to perform operations including scheduling meetings for a particular invitee within a predetermined time period. In some implementations, to schedule the plurality of meetings, the logic when executed is further operable to perform operations including scheduling meetings for a particular invitee on a same day. In some implementations, to schedule the plurality of meetings, the logic when executed is further operable to perform operations including grouping meetings for a particular invitee based on meeting locations.

### BRIEF DESCRIPTION OF THE DRAWINGS

FIG. 1 illustrates a block diagram of an example network environment, which may be used to implement the implementations described herein.

FIG. 2 illustrates an example simplified flow diagram for scheduling meetings, according to some implementations.

FIG. 3 illustrates an example simplified diagram of a calendar, according to some implementations.

FIG. 4 illustrates a block diagram of an example server device, which may be used to implement the implementations described herein.

### DETAILED DESCRIPTION

Implementations described herein provide scheduling of meetings. In various implementations, a system schedules meetings based on a variety of considerations. For example, such considerations may include the urgency of meetings, interdependency of meetings, temporal proximity of meetings, etc. These considerations and others as described in more detail below. In various implementations, the system receives meeting requests. The system then determines possible meeting times for each meeting based on the availability of meeting invitees.

The system then determines efficiency scores for the meetings, where each meeting is associated with an efficiency score, and each efficiency score is based on a combination of a number of factors such as those mentioned above (e.g., urgency of meetings, interdependency of meetings, temporal proximity of meetings, etc.). For example, if a first meeting needs to occur before a second meeting, the system associates a higher efficiency score to the first meeting than to the second meeting. In some implementations, each efficiency score may be based on the degree of urgency of the given meeting. For example, the system associates a higher score to a more urgent meeting than to a less urgent meeting. Other examples of efficiency scores are described in more detail below.

The system then schedules the meetings based on efficiency scores and availability of meeting invitees. For example, in various implementations, the system schedules meetings with higher efficiency scores first during times when predetermined invitees for each higher scoring meeting are available. The system then schedules meetings with lower scores during times when predetermined invitees for each lower scoring meeting are available.

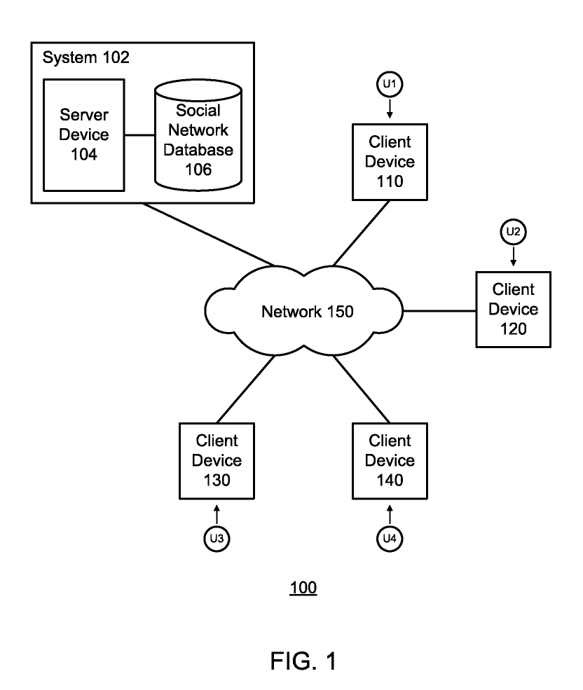

FIG. 1 illustrates a block diagram of an example network environment 100, which may be used to implement the implementations described herein. In some implementations, network environment 100 includes a system 102, which includes a server device 104 and a social network database 106. In various implementations, the term system 102 and phrase “social network system” may be used interchangeably. Network environment 100 also includes client devices 110, 120, 130, and 140, which may communicate with each other via system 102. Network environment 100 also includes a network 150.

For ease of illustration, FIG. 1 shows one block for each of system 102, server device 104, and social network database 106, and shows four blocks for client devices 110, 120, 130, and 140. Blocks 102, 104, and 106 may represent multiple systems, server devices, and social network databases. Also, there may be any number of client devices. In other implementations, network environment 100 may not have all of the components shown and/or may have other elements including other types of elements instead of, or in addition to, those shown herein.

In various implementations, users U1, U2, U3, and U4 may communicate with each other using respective client devices 110, 120, 130, and 140. For example, users U1, U2, U3, and U4 may interact with each other in a multi-user video conference, where respective client devices 110, 120, 130, and 140 transmit media streams to each other.

In the various implementations described herein, the processor of system 102 causes the elements described herein (e.g., messages, video streams, etc.) to be displayed in a user interface on one or more display screens.

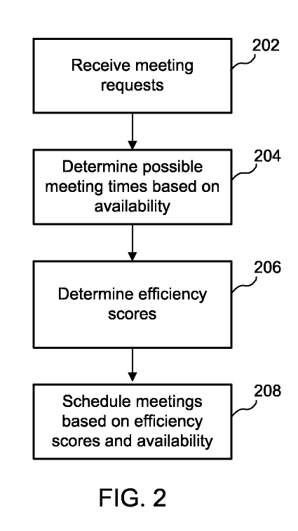

FIG. 2 illustrates an example simplified flow diagram for scheduling meetings, according to some implementations. Referring to both FIGS. 1 and 2, a method is initiated in block 202, where system 102 receives meeting requests for meetings.

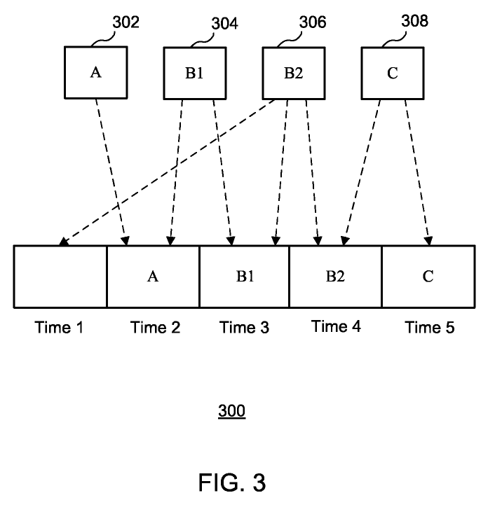

FIG. 3 illustrates an example simplified diagram of a calendar 300, according to some implementations. As shown, the calendar includes time slots Time 1, Time 2, Time 3, Time 4, and Time 5. In various implementations, the time slots Time 1 to Time 5 represent a chronological ordering. For examples, time slots Time 1 to Time 5 may represent days of the week (e.g., Monday, Tuesday, Wednesday, Thursday, Friday, etc.), times of the day (e.g., 10:00 am, 11:00 am, 12:00 pm, 1:00 pm, 2:00 pm, etc.), a combination of days and times, etc. As described in more detail below, in this particular example, time slot Time 1 is blank because there are no meetings scheduled during that time.

Also shown in FIG. 3 are meeting requests 302, 304, 306, and 308 (shown with meetings labeled A, B1, B2, and C). In various scenarios, meeting requests 302, 304, 306, and 308 may be received from different requestors, where each requestor may be a meeting organizer, administrator, etc.

Referring again to FIG. 2, in block 204, system 102 determines possible meeting times for each meeting based on the availability of meeting invitees. In some implementations, system 102 receives a list of invitees with each meeting request. Each invitee in each list is associated with available times (e.g., available days and times such as Time 1 through Time 5). In some implementations, each invitee in each list may also be associated with unavailable times (e.g., unavailable days and times). Such availability (available times, unavailable times, etc.) may be provided by the requestor and/or the invitees. Note that terms invitee and user may be used interchangeably.

Referring again to FIG. 3, the dotted lines indicate possible meeting times (e.g., time slots when at least all required invitees are available). In this particular example, a possible meeting time for meeting A is time slot Time 2. Possible meeting times for meeting B1 are time slots Time 2 and Time 3. Possible meeting times for meeting B2 are time slots Time 1, Time 2, and Time 3. Possible meeting times for meeting C are time slots Time 4 and Time 5. In various implementations, required invitees refer to situations where the presence of particular invitees are not optional. Note that in this particular example, meetings B1 and B2 are interdependent in that meeting B1 needs to occur before meeting B2. Example implementations associated with interdependency are described in more detail below.

Referring again to FIG. 2, in block 206, system 102 determines efficiency scores for the meetings. As indicated above, the efficiency score for a given meeting is based on a combination of efficiency sub-scores, which are in turn based on various aspects. As described in more detail below, such aspects involve factors that influence the potential difficulty (e.g., restrictions, requirements, urgency, etc.) in scheduling a given meeting. Such aspects may include, for example, urgency, interdependency, the particular invitees, temporal proximity, physical location, etc. Various example implementations are described in more detail below.

In block 208, system 102 schedules the meetings based on efficiency scores and availability of meeting invitees. More particularly, system 102 schedules the meetings in an order based on efficiency scores of meetings and also schedules meetings based on availability of meeting invitees for each of the meetings.

In some implementations, system 102 schedules meetings with higher efficiency scores first and then schedules meetings with lower efficiency scores. In some implementations, system 102 ranks the meetings from highest efficiency score to lowest efficiency score, and then schedules the meetings in order from highest to lowest ranking. This ensures that meetings with the highest efficiency scores have more options available on the calendar. This is beneficial for a number of reasons, one of which is that meetings with higher efficiency scores may have higher urgency and/or may be harder to schedule due to having more limitations/restrictions.

Referring again to FIG. 3, for this particular example, it is assumed that meeting A has the highest efficiency score, meeting B1 has the next highest efficiency score, meeting B2 has the next highest efficiency score, and meeting C has the lowest efficiency score. Example implementations as to how efficiency scores are generated are described in more detail below.

In various implementations, system 102 schedules meetings with higher efficiency scores earlier on the calendar than meetings with lower efficiency scores. In various implementations, system 102 schedules meetings with higher efficiency scores first during times when predetermined invitees for each higher scoring meeting are available. System 102 then schedules meetings with lower scores during times when predetermined invitees for each lower scoring meeting are available.

For example, system 102 may schedule meeting A first. As shown, time slot Time 2 is the only time slot available for meeting A. As such, system 102 schedules meeting A into time slot Time 2. System 102 then schedules meeting B1 into time slot Time 3, being the next available time slot for meeting B1 and the next available time slot on calendar 300. In a similar manner, system 102 schedules meeting B2 into time slot Time 4. Note that even though meeting B2 is available on time slot Time 1, meeting B1 needs to occur before B2. System 102 then schedules meeting C into time slot Time 5.

In various implementations, each of the meetings is associated with an efficiency score. As described in more detail below, the efficiency score for a given meeting weights the meeting with regard to the order in which system 102 schedules different meetings. For example, as described in more detail below, in various implementations, system 102 schedules meetings with higher efficiency scores before meetings with lower efficiency scores.

In various implementations, efficiency scores are based on a combination of different aspects. In various implementations, efficiency scores are based on a combination of different aspects in that, for each meeting, system 102 generates an efficiency sub-score for each of one or more different aspects associated with each meeting. For example, as indicates herein, such aspect may include urgency, interdependency, the particular invitees, temporal proximity, physical location, etc. For each meeting, system 102 then aggregates the efficiency sub-scores into an efficiency score.

In various implementations, system 102 recomputes efficiency scores, including efficiency sub-scores, as system 102 receives new meeting requests or receives changes to meeting requests. In various implementations, system 102 reranks meetings based on their respective efficiency scores each time system 102 schedules a meeting. This ensures that system 102 optimally schedules subsequent meetings that are yet to be scheduled.

In some implementations, each efficiency score may be based on a degree of urgency. In various implementations, the user may indicate the degree of urgency of a given meeting. For example, the user may specify that a given meeting has a high urgency, a medium urgency, or a low urgency. In various implementations, system 102 gives a relatively higher efficiency sub-score to a given meeting that is more urgent than another meeting. For example, system 102 may give a meeting that has a high urgency an efficiency sub-score of 3. System 102 may give a meeting that has a medium urgency an efficiency sub-score of 2. System 102 may give a meeting that has a low urgency an efficiency sub-score of 1. For ease of illustration, whole numbers are used for the example efficiency sub-scores described herein. The particular number scheme used will depend on the particular implementation. For example, system 102 may use decimals for the efficiency sub-scores. Furthermore, the particular range of numbers used for a range of efficiency sub-scores will depend on the particular implementation.

In some implementations, system 102 may give a meeting that needs to occur as soon as possible, the same or next day, etc., a relatively higher efficiency sub-score with regard to urgency (e.g., an efficiency sub-score of 4). In some implementations, if a given meeting has a due date, system 102 may guarantee that the meeting is scheduled at least by the due date regardless of the ultimate efficiency score. System 102 gives a meeting that has little no urgency a relatively lower high efficiency sub-score with regard to urgency (e.g., an efficiency sub-score of 0).

In some implementations, each efficiency score may be based on interdependencies among meetings. In various implementations, the user may indicate interdependencies among given meetings. For example, the user may specify that a given meeting (e.g., meeting B1) needs to precede another meeting (e.g., meeting B2). In some implementations, system 102 gives a relatively higher efficiency sub-score to first meeting that needs to occur before a second related meeting with regard to interdependency. If there is a third related meeting, system 102 gives a relatively higher efficiency sub-score to the second meeting that needs to occur before the third meeting with regard to interdependency. For example, system 102 may give a meeting that needs to occur first an efficiency sub-score of 3. System 102 may give a meeting that needs to occur second an efficiency sub-score of 2. System 102 may give a meeting that needs to occur third an efficiency sub-score of 1. In some implementations, if a given set of meetings has interdependencies, system 102 may guarantee that those meetings are scheduled in the specified order regardless of their ultimate efficiency scores.

In some implementations, each efficiency score may be based on one or more invitees invited to a particular meeting. In various implementations, system 102 may determine the number of invitees to a given meeting. As such, system 102 gives a higher efficiency sub-score to a given meeting that requires a greater number of invitees to attend than to a meeting that requires a smaller number of invitees to attend with regard to invitees. For example, system 102 may give a meeting that has 4 invitees an efficiency sub-score of 4. System 102 may give meeting has 2 invitees an efficiency sub-score of 2. As indicated above, the particular range of numbers used for a range of efficiency sub-scores will depend on the particular implementation. In some implementations, the number of required invitees includes invitees that are non-optional, where the efficiency sub-score might not take into account optional invitees. In some implementations, system 102 gives more weight to non-optional invitees than to optional invitees. In some implementations, system 102 still gives some weight to optional invitees. These implementations ensure that system 102 is more likely to schedule meetings that require more non-optional invitees first.

In various implementations, the user may indicate an importance of one or more invitees to a given meeting. For example, the user may specify that a given invitee is the president of a company. As such, system 102 may give such a meeting with the president as an invitee a relatively higher efficiency sub-score of 5 with regard to invitees, and give another meeting with all non-executive invitees as relatively lower efficiency sub-score of 1 with regard to invitees. In other words, the efficiency sub-score may be proportional to the invitee's ranking in the organization.

In some implementations, each efficiency score may be based on temporal proximity to other meetings. For example, with regard to temporal proximity, in some implementations, system 102 compares the list of invitees to meetings to be scheduled to the list of invitees to meetings that are already scheduled. System 102 gives a higher efficiency sub-score to a given meeting to be scheduled where one or more invitees are already scheduled to attend one or more other meetings close in time. For example, system 102 may give a meeting to be scheduled a relatively higher efficiency sub-score (e.g., an efficiency sub-score of 3) if one or more of invitees to the meeting are attending one or more already scheduled meetings that are close in time to the meeting to be scheduled. In some implementations, the efficiency sub-score may be proportional to the number of invitees to the meeting, where those invitees are attending one or more already scheduled meetings that are close in time to the meeting to be scheduled. In some implementations, the efficiency sub-score may be proportional to the number of already scheduled meetings that are scheduled close in time to the meeting to be scheduled.

In some implementations, system 102 may give meetings a higher efficiency score when the invitees are located different time zones. In some implementations, the efficiency sub-scores may be proportional to the differences in time zones. Furthermore, system 102 may schedule such meetings such that they occur as close as possible to hours of the day that are within overlapping business hours of most invitees. For example, system 102 may schedule a given meeting at 8:00 pm Pacific Standard Time and 5:00 pm Central European Time, where the invitees are in California and Stockholm in order for the meeting to occur at a convenient time for most invitees.

Related to temporal proximity, in some implementations, the scheduling of the plurality of meetings includes scheduling meetings for a particular invitee within a predetermined time period. For example, system 102 give a higher efficiency sub-score (e.g., an efficiency sub-score of 2) to a given meeting to be scheduled where one or more invitees are already scheduled to attend one or more other meetings within a predetermined time period. In some implementations, the scheduling of the meetings may include scheduling meetings for a particular invitee on a same day. The predetermined time period will depend on the particular implementation. For example, the predetermined time period may be the same part of the day (e.g., morning, afternoon, etc.), same time window (e.g., 10:00 am-2:00 pm, 4:00 pm-6:00 pm, etc.). This increases the likelihood that meetings for a given invitee are clustered, and that the given invitee has more and/or longer meeting-free time blocks during the week, which optimizes available non-meeting work time.

In some implementations, the scheduling of the plurality of meetings includes grouping meetings for a particular invitee based on physical meeting locations. For example, with regard to meeting locations, in some implementations, system 102 compares the list of invitees to meetings to be scheduled to the list of invitees to meetings that are already scheduled. System 102 gives a higher efficiency sub-score (e.g., an efficiency sub-score of 2) to a given meeting to be scheduled, where one or more invitees are already scheduled to attend one or more other meetings close in physical distance. This increases the likelihood that system 102 schedules meetings for a particular invitee physically close to one another. For example, in some implementations, system 102 may schedule meetings for a particular invitee in a same building. By scheduling meetings based on physical distances between meeting locations, system 102 optimizes travel times for invitees between different rooms or locations.

In some implementations, system 102 schedules meetings based on a number of meeting participants at each location. In some implementations, system 102 may give a higher efficiency sub-score to a given meeting with a number of invitees that is proportional to the size of a given meeting room. For example, for a given large meeting room, system 102 may give a higher efficiency sub-score to a meeting with a larger number of invitees (e.g., an efficiency sub-score of 5 for 5 invitees). In contrast, for a given small meeting room, system 102 may give a higher efficiency sub-score to a meeting with a smaller number of invitees (e.g., an efficiency sub-score of 2 for 2 invitees).

In some implementations, system 102 may aggregate the efficiency sub-scores to an efficiency score (e.g., a total efficiency score) by adding the efficiency sub-scores. Other aggregation schemes are possible. For example, in some implementations, system 102 may aggregate the efficiency sub-scores to an efficiency score by averaging the efficiency sub-scores.

In some implementations, system 102 determines when there is a change to an ending of a first meeting. System 102 makes such a determination in read-time as meetings end. System 102 then reschedules at least a second meeting based on the change. For example, if a given meeting that is schedule for 2:15 pm to 3:00 pm, and that meeting ends at 2:35 pm. System 102 may reschedule a subsequent meeting that starts at 3:00 pm to 2:45 pm, if the required invitees are available. System 102 may determine if someone is already in a discussion or not, and if the person is free to be rescheduled as appropriate. This enables variable length meetings rather than meeting times based on fixed boundaries. Also, implementations enable dynamic rescheduling of meetings if they end early or run overtime.

Implementations described herein provide various benefits. For example, dynamically scheduled meetings may be based a variety of aspects such as urgency, interdependency, the particular invitees, temporal proximity, physical location, etc. Implementations described herein also increase overall productivity among users.

Although the steps, operations, or computations may be presented in a specific order, the order may be changed in particular implementations. Other orderings of the steps are possible, depending on the particular implementation. In some particular implementations, multiple steps shown as sequential in this specification may be performed at the same time. Also, some implementations may not have all of the steps shown and/or may have other steps instead of, or in addition to, those shown herein.

While system 102 is described as performing the steps as described in the implementations herein, any suitable component or combination of components of system 102 or any suitable processor or processors associated with system 102 may perform the steps described.

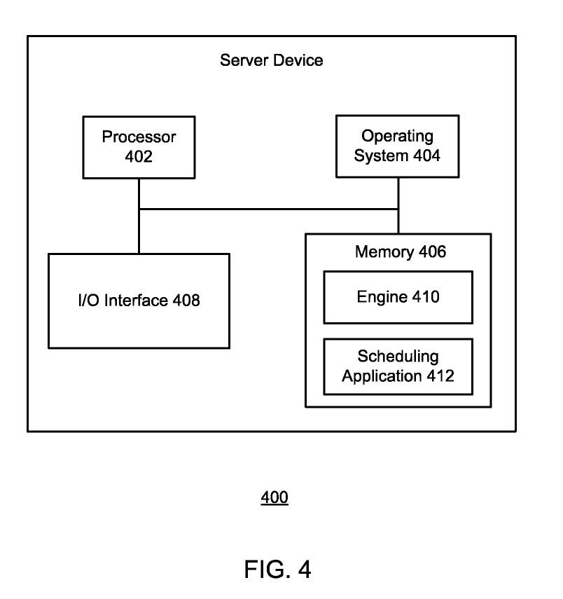

FIG. 4 illustrates a block diagram of an example server device 400, which may be used to implement the implementations described herein. For example, server device 400 may be used to implement server device 104 of FIG. 1, as well as to perform the method implementations described herein. In some implementations, server device 400 includes a processor 402, an operating system 404, a memory 406, and an input/output (I/O) interface 408. Server device 400 also includes an engine 410 and a scheduling application 412, which may be stored in memory 406 or on any other suitable storage location or computer-readable medium. Scheduling application 412 provides instructions that enable processor 402 to perform the functions described herein and other functions.

For ease of illustration, FIG. 4 shows one block for each of processor 402, operating system 404, memory 406, I/O interface 408, engine 410, and scheduling application 412. These blocks 402, 404, 406, 408, 410, and 412 may represent multiple processors, operating systems, memories, I/O interfaces, social network engines, and media applications. In other implementations, server device 400 may not have all of the components shown and/or may have other elements including other types of elements instead of, or in addition to, those shown herein.

Although the description has been described with respect to particular embodiments thereof, these particular embodiments are merely illustrative, and not restrictive. Concepts illustrated in the examples may be applied to other examples and implementations. For example, some implementations are described herein in the context of a social network system. However, the implementations described herein may apply in contexts other than a social network. For example, implementations may apply locally for an individual user.

Note that the functional blocks, methods, devices, and systems described in the present disclosure may be integrated or divided into different combinations of systems, devices, and functional blocks as would be known to those skilled in the art.

Any suitable programming languages and programming techniques may be used to implement the routines of particular embodiments. Different programming techniques may be employed such as procedural or object-oriented. The routines may execute on a single processing device or multiple processors. Although the steps, operations, or computations may be presented in a specific order, the order may be changed in different particular embodiments. In some particular embodiments, multiple steps shown as sequential in this specification may be performed at the same time.

A “processor” includes any suitable hardware and/or software system, mechanism or component that processes data, signals or other information. A processor may include a system with a general-purpose central processing unit, multiple processing units, dedicated circuitry for achieving functionality, or other systems. Processing need not be limited to a geographic location, or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory. The memory may be any suitable data storage, memory and/or non-transitory computer-readable storage medium, including electronic storage devices such as random-access memory (RAM), read-only memory (ROM), magnetic storage device (hard disk drive or the like), flash, optical storage device (CD, DVD or the like), magnetic or optical disk, or other tangible media suitable for storing instructions for execution by the processor. The software instructions can also be contained in, and provided as, an electronic signal, for example in the form of software as a service (SaaS) delivered from a server (e.g., a distributed system and/or a cloud computing system).

1. A method comprising:
receiving meeting requests for a plurality of meetings, wherein the meetings are conducted via individual communication sessions on a respective computer device of participants of the respective meeting of the plurality of meetings;
determining efficiency scores for the plurality of meetings, wherein each meeting of the plurality of meetings is associated with an efficiency score, wherein each efficiency score is based on interdependencies among the plurality of meetings, wherein each efficiency score is based on a degree of urgency, and wherein the efficiency score is further based one or more of the participants to a respective meeting of the plurality of meetings also being a participant to a previously scheduled other meeting occurring during a predetermined time period;
determining a first time for the respective meeting of the plurality of meeting, wherein the first time is temporally proximal to the previously scheduled other meeting to provide at least one meeting free time block for the one or more of the participants of the respective meeting;
scheduling the plurality of meetings based on the efficiency scores and the first time for the respective meeting, wherein scheduling of the plurality of meetings comprises scheduling a first meeting of the plurality of meetings with a first efficiency score prior to scheduling a second meeting of the plurality of meetings with a second efficiency score, wherein the first efficiency score indicates a greater efficiency than an efficiency indicated by the second efficiency score, wherein the scheduling comprises scheduling at least one meeting of the plurality of meetings for a particular invitee within the predetermined time period; and wherein the first efficiency score and the second efficiency score further indicate a respective number of required invitees and a respective number of optional invitees and the first efficiency score includes a greater efficiency for at least one important invitee that is high ranking within an entity of at least one of the invitees of the first meeting; and
causing, according to the scheduling, display of the individual communication sessions on the respective computer device of participants for each of the plurality of meetings.

2. A method comprising:
receiving meeting requests to schedule at least a first meeting and a second meeting, wherein the first meeting and the second meeting are conducted via individual communication sessions on computer devices of participants provided in a first invitee list for the first meeting and a second invitee list for the second meeting, wherein the first invitee list includes at least one invitee not included in the second invitee list;
determining whether one or more first invitees from the first invitee list and one or more second invitees from second invitee list are included in a third invitee list to a third meeting previously scheduled to occur at a third meeting time period;
determining a respective efficiency score for each of the first meeting and the second meeting, based, at least in part, on whether the one or more first invitees and the one or more second invitees are included in the third invitee and further based on a sub-score proportional to differences in time zones for each invitee in the first invitee list and the second invitee list;
determining a first time for the first meeting, wherein the first time is temporally proximal to and on a same day as the second meeting to optimize meeting-free time on a same day for a particular invitee; and
scheduling the first meeting and the second meeting by providing a meeting appointment in a calendar application of the participants for each of the first meeting and respective time periods proximal the third meeting time period based on the respective efficiency scores, according to the first time for the first meeting, and further scheduled during or proximal to business hours for the invitees.

3. (canceled)

4. The method of claim 2, wherein each respective efficiency score is based, at least in part, on interdependencies between the first meeting and the second meeting, wherein one of the first meeting and the second meeting is needed to occur prior to the other.

5. The method of claim 2, wherein each respective efficiency score is further based on a degree of urgency.

6. (canceled)

7. The method of claim 2, wherein an order of the scheduling includes the one of the first meeting and the second meeting with the respective efficiency score indicating a greater efficiency than indicated by the respective efficiency score of the other meeting, is scheduled prior to scheduling the other meeting.

8. The method of claim 2, wherein the scheduling comprises clustering the first meeting and the second meeting for a particular invitee within a predetermined time period.

9. (canceled)

10. (canceled)

11. The method of claim 2, further comprising:
determining when there is a change to an ending of a first meeting; and
rescheduling at least a second meeting based on the change.

12. A system comprising:
one or more processors; and
logic encoded in one or more tangible media for execution by the one or more processors and when executed operable to perform operations comprising:
receiving meeting requests to schedule at least a first meeting and a second meeting, wherein the first meeting and the second meeting are conducted via individual communication sessions on computer devices of participants provided in a first invitee list for the first meeting and a second invitee list for the second meeting, wherein the first invitee list includes at least one invitee not included in the second invitee list;
determining whether one or more first invitees from the first invitee list and one or more second invitees from second invitee list are included in a third invitee list to a third meeting previously scheduled to occur at a third meeting time period;
determining a respective efficiency score for each of the first meeting and the second meeting, based, at least in part, on whether the one or more first invitees and the one or more second invitees are included in the third invitee list and further based on a sub-score proportional to differences in time zones for each invitee in the first invitee list and the second invitee list;
determining a first time for the first meeting, wherein the first time is temporally proximal to and on a same day as the second meeting to optimize meeting-free time on a same day for a particular invitee; and
scheduling the first meeting and the second meeting by providing a meeting appointment in a calendar application of the participants for each of the first meeting and the second meeting, wherein an order of the scheduling is based on the respective efficiency scores, and wherein the first meeting and the second meeting are scheduled for respective time periods proximal the third meeting time period based on the respective efficiency scores, according to the first time for the first meeting, and further scheduled during or proximal to business hours for the invitees.

13. (canceled)

14. The system of claim 12, wherein each respective efficiency score is based, at least in part, on interdependencies between the first meeting and the second meeting, wherein one of the first meeting and the second meeting is needed to occur prior to the other.

15. The system of claim 12, wherein each respective efficiency score is further based on a degree of urgency.

16. (canceled)

17. The system of claim 12, wherein the order of the scheduling includes the one of the first meeting and the second meeting with the respective efficiency score indicating a greater efficiency than the efficiency indicated by the respective efficiency score of the other meeting, is scheduled prior to scheduling the other meeting.

18. The system of claim 12, wherein the logic when executed is further operable to perform operations comprising clustering the first meeting and the second meeting for a particular invitee within a predetermined time period.

19. (canceled)

20. (canceled)

21. The method of claim 2, wherein each of the respective efficiency score is based on two or more efficiency sub-scores for individual aspects of the first meeting and the second meeting.

22. The system of claim 12, wherein each of the respective efficiency score is based on two or more efficiency sub-scores for individual aspects of the first meeting and the second meeting.

23. The method of claim 2, wherein each of the respective efficiency scores is proportional to a number of invitees of the one or more first invitees and the one or more second invitees are included in the third invitee list.

24. The system of claim 12, wherein each of the respective efficiency scores is proportional to a number of invitees of the one or more first invitees and the one or more second invitees are included in the third invitee list.
